(19) United States
(12) Patent Application Publication
(10) Pub. No.: US 2005/0235205 A1
(43) Pub. Date: Oct. 20, 2005

(54) Touch panel key input system for POS system

(75) Inventor: Hiroyasu Hasegawa, Kanagawa (JP)

Correspondence Address: FOLEY AND LARDNER;SUITE 500, 3000 K STREET NW, WASHINGTON, DC, 20007, US

(73) Assignee: NEC Infrontia Corporation

(21) Appl. No.: 11/063,727

(22) Filed: Feb. 24, 2005

(30) Foreign Application Priority Data
Feb. 7, 2003 (JP) 2003-030247

(51) Int. Cl. G06F 3/02

(52) U.S. Cl. 715/702

(57) ABSTRACT

Predetermined particular sounds and/or messages are assigned separately to a plurality of keys, respectively, and the assigned particular sounds and/or messages are generated and outputted in response to the touch to predetermined keys. Predetermined sounds and/or messages are assigned to a key group having a plurality of keys, and the assigned particular sounds and/or messages are generated and outputted in response to the touch to keys, respectively, in the key group. Predetermined particular sounds and/or messages are assigned to erroneous touch operations, respectively, with respect to predetermined keys, and the assigned sounds and/or messages are generated and outputted in response to the erroneous touch operations, respectively. The error touch operations are classified into a plurality of levels according to the gravity of the errors, the predetermined particular sounds and/or messages being assigned to the error gravity levels, respectively, and the assigned particular sounds and/or messages are generated and outputted in response to the error touch operation levels.

### BACKGROUND OF INVENTION

The present invention relates to touch panel key input systems for POS system.

In the POS system used in, for instance, fast food shops or the like, touch keys disposed on a touch panel in correspondence to goods, respectively, are used as means for inputting sales and order goods data. In many cases, at the time of goods data input by using touch keys on such a touch panel as noted above, a special beep sound is generated to notify the key touch to the operator in response to the key touch thereby.

FIG. 15 shows an example of sales input view of a prior art sales data input unit for POS system. Referring to FIG. 15, keys corresponding to commercial goods, respectively, are disposed and displayed on the right side. In a left side upper part, sales goods names are displayed, and in a right side lower part the sales amount details of the sold goods are displayed. When an operator (e.g., employee) touches a touch key of the good bought by the client, the beep sound is generated to notify the touch to (i.e., operation of) the key to the operator. For example, when a “drink” key is touched, a predetermined beep sound is generated.

However, in the above prior art touch panel key input system for POS system, the key touch sound is generated purely for the purpose of confirmation, i.e., to notify the key touch to the operator, and it is not used for any other purpose. Besides, the confirmation sound is fixed. In other words, the key touch sound corresponding to the touched key can not be varied to meet various desires.

### SUMMARY OF INVENTION

An object of the present invention, accordingly, is to provide a touch panel key input system for POS system capable of facilitating the confirmation of key operation for reducing input errors.

Another object of the present invention is to provide a touch panel key input system for POS system capable of easily confirming a key operation belonging to a key group for improving the work efficiency.

A further object of the present invention is to provide a touch panel key input system for POS system, which is capable of generating and outputting a special alarm sound or message in the event of an error or the operation of a key intrinsically having a serious problem.

According to an embodiment of the present invention, there is provided a touch panel key input system for POS system for inputting desired data by key touch, wherein predetermined particular sounds and/or messages are assigned separately to a plurality of keys, respectively, and the assigned particular sounds and/or messages are generated and outputted in response to the touch to predetermined keys.

According to another embodiment of the present invention, there is provided a touch panel key input system for POS system for inputting desired data by key touch, wherein predetermined sounds and/or messages are assigned to a key group having a plurality of keys, and the assigned particular sounds and/or messages are generated and outputted in response to the touch to keys, respectively, in the key group.

The particular sounds and/or messages each designate a next touch operation to be done.

According to another embodiment of the present invention, there is provided a touch panel key input system for POS system for inputting desired data by key touch, wherein predetermined particular sounds and/or messages are assigned to erroneous touch operations, respectively, with respect to predetermined keys, and the assigned sounds and/or messages are generated and outputted in response to the erroneous touch operations, respectively.

The error touch operations are classified into a plurality of levels according to the gravity of the errors, the predetermined particular sounds and/or messages being assigned to the error gravity levels, respectively, and the assigned particular sounds and/or messages are generated and outputted in response to the error touch operation levels. The erroneous touch operations are displayed in a view. The particular sounds and/or messages are generated and outputted from a predetermined particular sound generator. The display of the erroneous touch operations is made in a predetermined particular view. The display of the erroneous touch operations is of a status different from the usual display status. The display of the erroneous touch operations is a link display. The plurality of levels of the error gravity is determined by the significance of the result of key touch operations. The plurality of levels of error gravity are set up by assuming the case when a key which should not be operated from the consideration of immediately preceding input data is operated, the case when an ineffective key is operated, the case when numerical figures which should not be present are inputted from a ten-key set, the case when a key which can be readily used or for illegal operation such as a slip cancel key or a goods correction key and also a key which is allowed to be operated by a particular person such as manager are operated, and the case when a cash reception box is operated.

Other objects and feature of the present invention will be clarified from the following description with reference to the attached drawings.

### BRIEF DESCRIPTION OF DRAWINGS

FIG. 1 is a view showing the manner of generation and output of preset and registered sound and/or message at the time of a predetermined key touch in an embodiment of the present invention;

FIG. 2 is a view showing the manner of generation and output of sound and/or message corresponding to a key group, which is assigned to goods included in a goods group in the embodiment of the present invention, at the time when a key belonging to the key group is touched;

FIG. 3 is a view showing the manner of generation and output of sound and/or message at the time of erroneous key touch and process in the embodiment of the present invention;

FIG. 4 is a view showing the manner of generation and output of preset sound and/or message at the time of key touch as erroneous process in the embodiment of the present invention;

FIG. 5 is a view showing a method of information to operator in a different embodiment of the present invention;

FIG. 6 is a view showing the manner of generation and output of predetermined sound and/or message at the time of touching a sales line in a further embodiment of the present invention;

FIG. 7 is a view showing the correlation of sales data, goods attribute table, goods discount table and sound data master in the embodiment of the present invention;

FIG. 8 is a view showing an example of sales line data in the embodiment of the present invention;

FIG. 9 is a view showing an example of view display in the embodiment of the present invention;

FIG. 10 is a view showing the relation between keys and sound data, i.e., sound/data link, in the embodiment of the present invention;

FIG. 11 is a view showing the relation between key groups and sound data, i.e., sound/data link, in the embodiment of the present invention;

FIG. 12 is a view showing an error sound data configuration in the embodiment of the present invention;

FIG. 13 is a sound data flow chart showing a sound generation process routine in the embodiment of the present invention;

FIG. 14 is an error process flow chart showing an error sound generation process routine in the embodiment of the present invention; and

FIG. 15 is a view showing an example of a sales input view on a prior art POS system sales input unit.

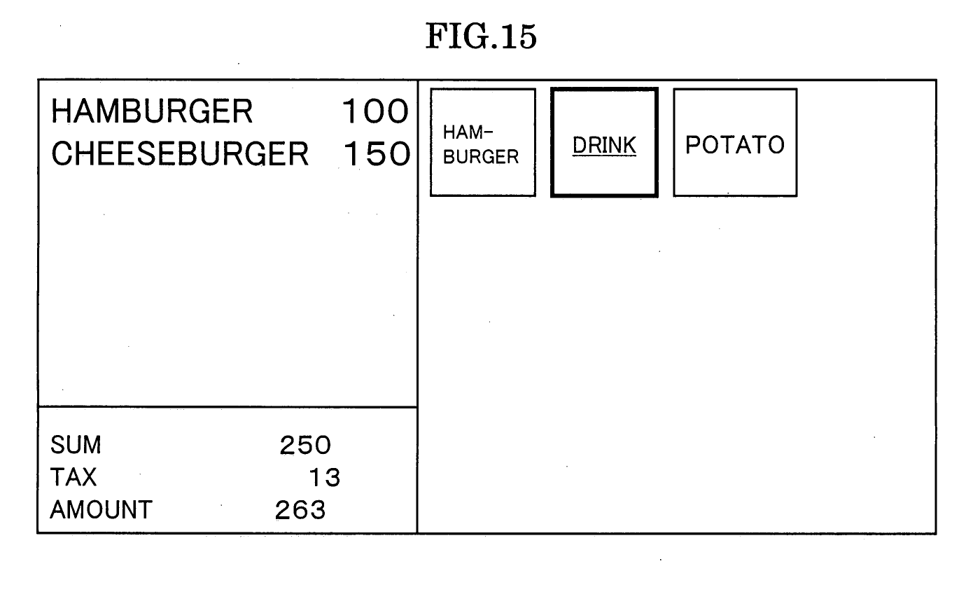

### PREFERRED EMBODIMENTS OF INVENTION

Now, a preferred embodiment of the touch panel key input system for POS system according to the present invention will be described in detail with reference to the accompanying drawings.

In the present invention, a predetermined sound and/or message is outputted when a desired key or key group among goods keys or a ten-key set on a POS system touch panel is touched or when a predetermined view (such as view display at the time of error) is displayed. Sound and/or message data for generating and outputting such sounds and/or messages are stored as file in memory. At the time of causing output of an error message as sound and/or message, a predetermined sound/message is generated and outputted based on the gravity level (i.e., degree of hazardousness or significance).

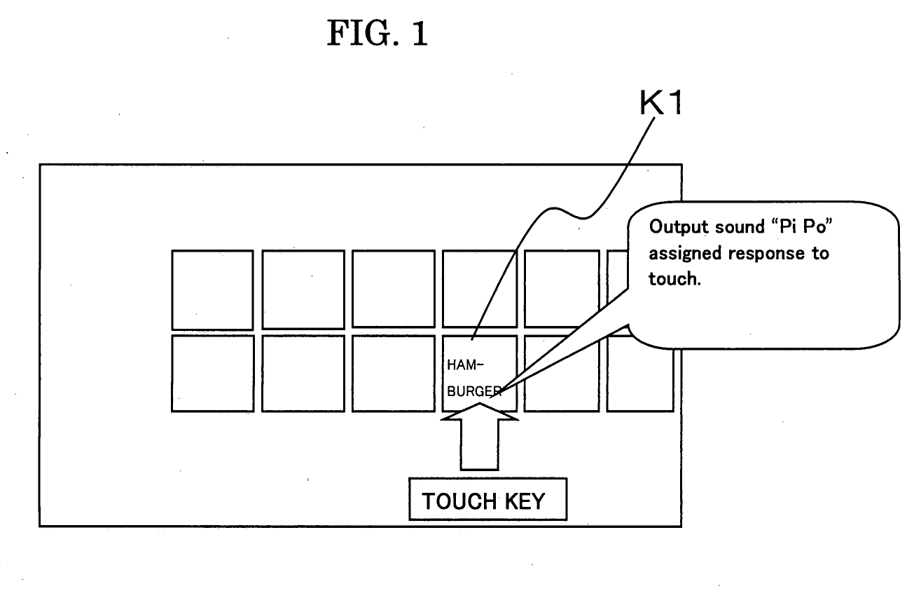

FIGS. 1 to 3 are simplified key array views for describing the concept underlying the generation and output of a predetermined sound and/or message in response to a key touch in an embodiment of the touch panel key input system for POS system according to the present invention.

Referring to FIG. 1, separate sounds and/or messages are assigned to a plurality of keys, respectively. When a predetermined key K1 is touched, unlike the fixed beep sound as in the prior art, a preliminarily assigned preset sound/message is generated and outputted. For example, when a “hamburger” key as key K1 is touched, a sound and/or a voice saying “Please select condiment.” are outputted. In this way, the next operation (i.e., key data input) that is necessary is reliably informed to the operator, thus permitting reliable and quick operation.

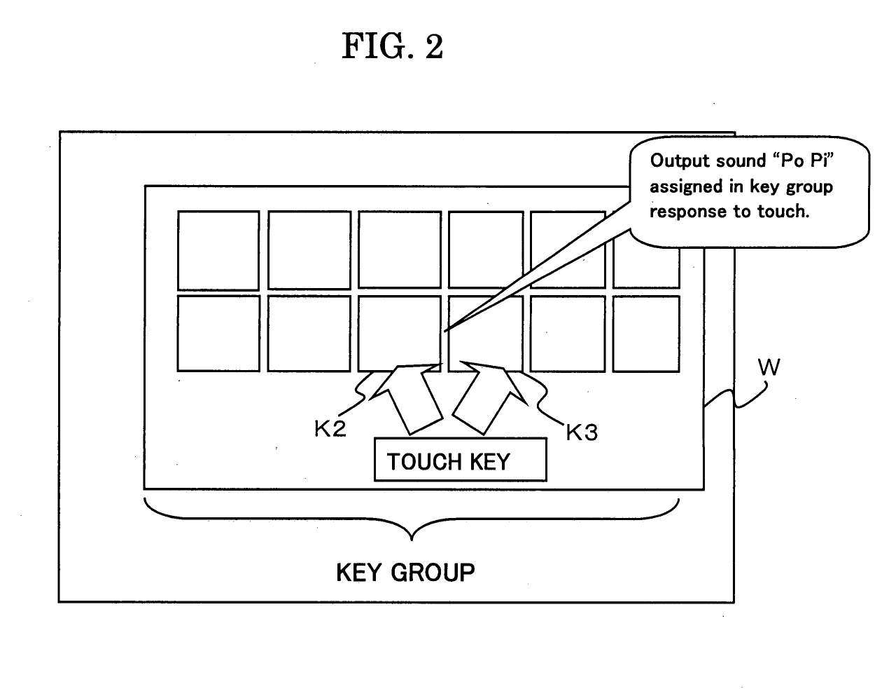

In the case of FIG. 2, when a key in a key group assigned to goods included in a predetermined goods group is touched on the basis of goods kinds or the like, a sound and/or a message corresponding to this key group are generated and outputted. For example, when a key K2 among the keys enclosed in a key group frame W in FIG. 2 is touched, a sound and/or a message assigned (i.e., set up) in correspondence to that key group are generated and outputted. In the case when a sound and/or a message peculiar to any one of the keys are preset, the peculiar key sound and/or message may first be generated and outputted. Conversely, the peculiar key sound and/or message may be generated and outputted after generation and output of a sound and/or a message corresponding to the key group. Since it is possible to set up a sound and/or message for a key group, a sound and/or a message need not be set up for each of the keys in the key group. Thus, it is possible to improve the work efficiency.

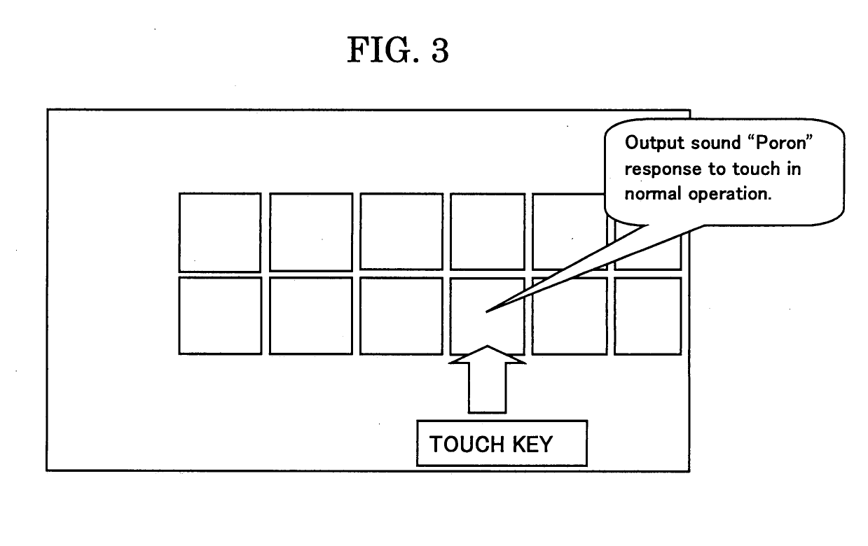

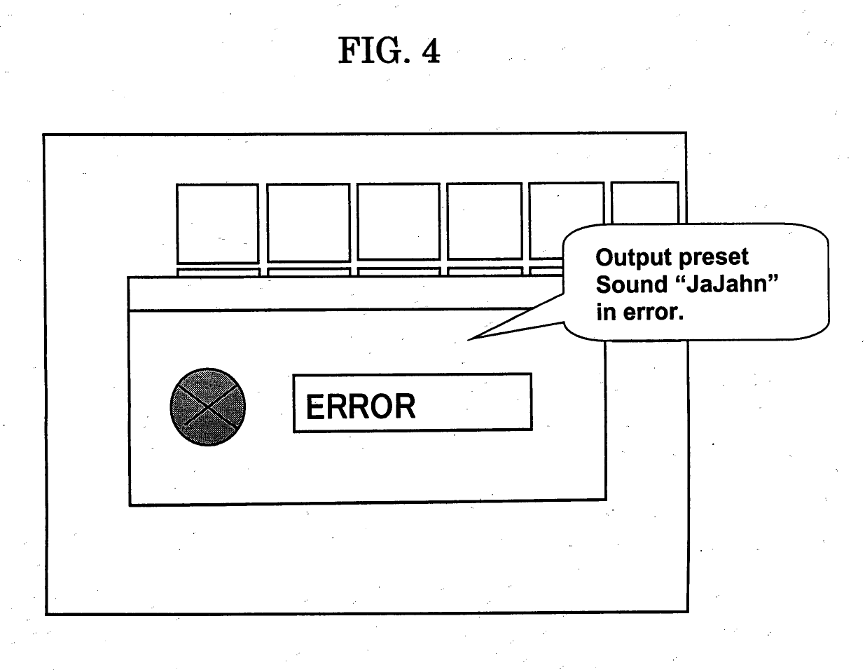

FIG. 3 shows a case, in which a key touch on a view for causing predetermined operations, such as sales goods input and sales settling, of the POS system is an erroneous operation or process (or touch), separate sound and/or message different from the normally generated and outputted sound and/or message are generated and outputted. For example, when the key touch is a normal process operation, such a sound as “boron” is outputted, while in the case of an erroneously operated key a sound and/or a message expressing a special alarm are generated and outputted. Such an example will now be described with reference to FIG. 4.

FIG. 4 shows an example, in which when the key touch is an erroneous operation, i.e., erroneous process, a preset sound (for instance “jajajahn”) is generated and outputted. In this case, an error message such as “This is an error.” may be displayed in the view. It is also possible to generate and output a predetermined sound or message according to the gravity level (i.e., degree of hazard or significance) of the error.

The error gravity level can be determined by the magnitude of the gravity of the result of the key touch operation. As an example, in the case of setting levels 1 to 3 in the lower gravity level order, the level 1 is assumed to correspond to the case that a key which should not be operated as judged from the immediately processing input data is operated or the case that an ineffective key is operated. The level 2 is assumed to correspond to, for instance, the case that a numerical figure which should not be present at the time of numerical figure input is inputted from the ten-key set (for example, when a discount rate of 100% or a discount price higher than the original price is inputted). The level 3 is assumed to correspond to the case that a key able to be readily illegally used such as a slip cancel key or a goods correction key or a key operable by a particular person such as a manager is operated or the case that a cash reception box is operated. With this arrangement of generating and outputting a changed sound or message according to the error gravity level, an error can be immediately recognized to permit quick coping with the error. In the case of the level 3, it is possible to notify the error with a louder level sound or a featuring sound to let the situation be reliably known to nearby persons or a particular person (such as a manager). Also, it is possible in this case to output a sound or a view from a voice producing unit or a display unit used by a particular person.

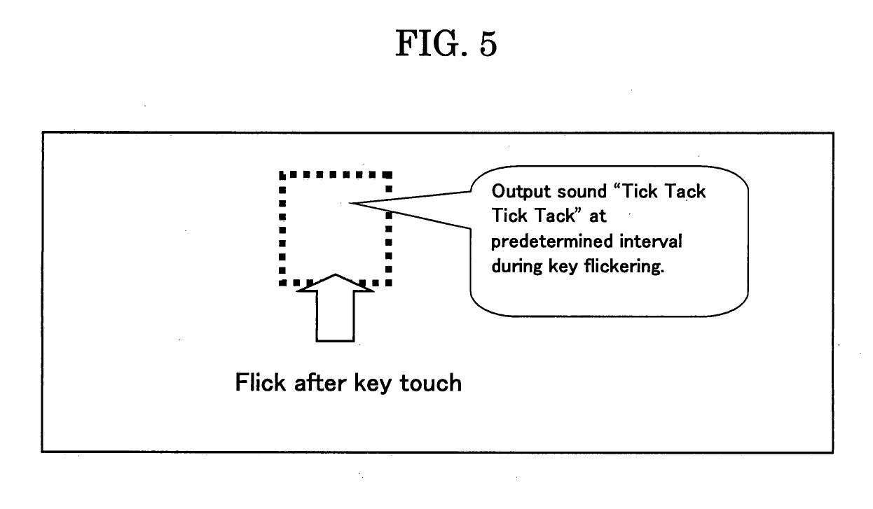

FIG. 5 shows a method of notification to the operator in a different embodiment of the present invention. In this embodiment, the touched key is displayed by flicker display, or a particular sound (for instance “ticktack ticktack . . . ” sound) is generated and outputted at a predetermined interval during error view display or key flicker display. Instead of the key flicker display, it is possible to change the display color or provide display in a different status from the normal one. In this way, it is possible to provide a reliable alarm both visually and acoustically.

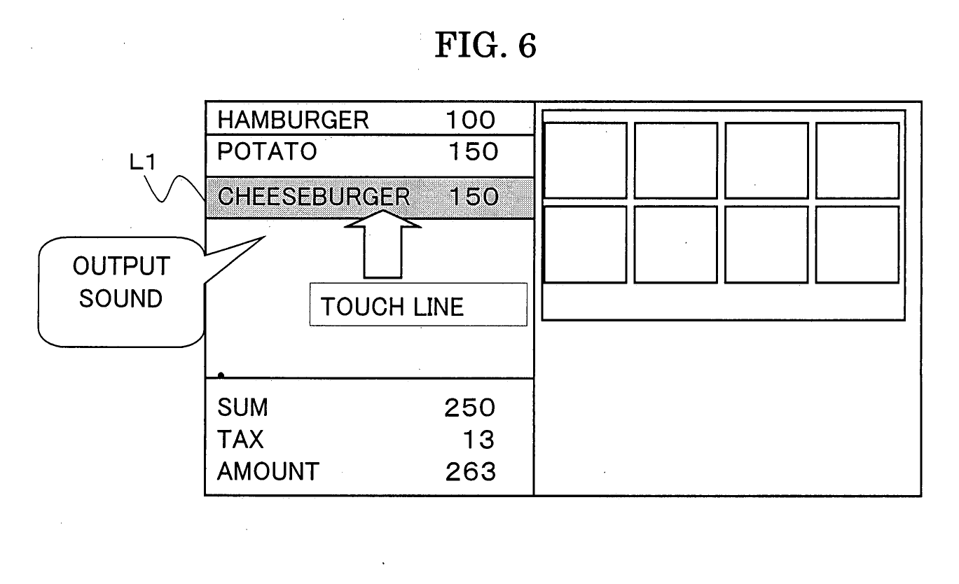

FIG. 6 is a view showing a further embodiment of the present invention. In this embodiment, predetermined sound and/or message are outputted when a sales line is touched. By the term “sales line” is meant a line in the sales view which should be touched when executing a discount or like process with respect to sold goods.

Like the case of FIG. 5, the Figure shows good keys displayed on the right side, sales goods names displayed in a left side upper part, and a sales detail part with respect to sold goods displayed in a left side lower part. For example, by touching a cheeseburger sales line Ll when cheeseburger is a discount good, particular sound and/or message are generated and outputted to notify the discount good. Sound and/or message are linked to the goods attribute of the sales line, and at the time of the sales line touch a particular sound and/or message expressing that the pertinent good is a discount good are generated and outputted. In the case of a non-discount good, sound and/or message of the good attribute may be generated and outputted, or no nothing may be outputted.

In the meantime, the discount of goods is made only once to one customer. To execute the discount process two or more times with respect to a pertinent good is an erroneous operation made to the good which has already been discounted. To prevent such erroneous operation, according to the present invention when the sales line is touched two or more times, particular sound and/or message are generated and outputted as described above (see FIG. 4 or 5) to notify the erroneous operation to the operator (in charge of register) and thus prevent undesired error occurrence.

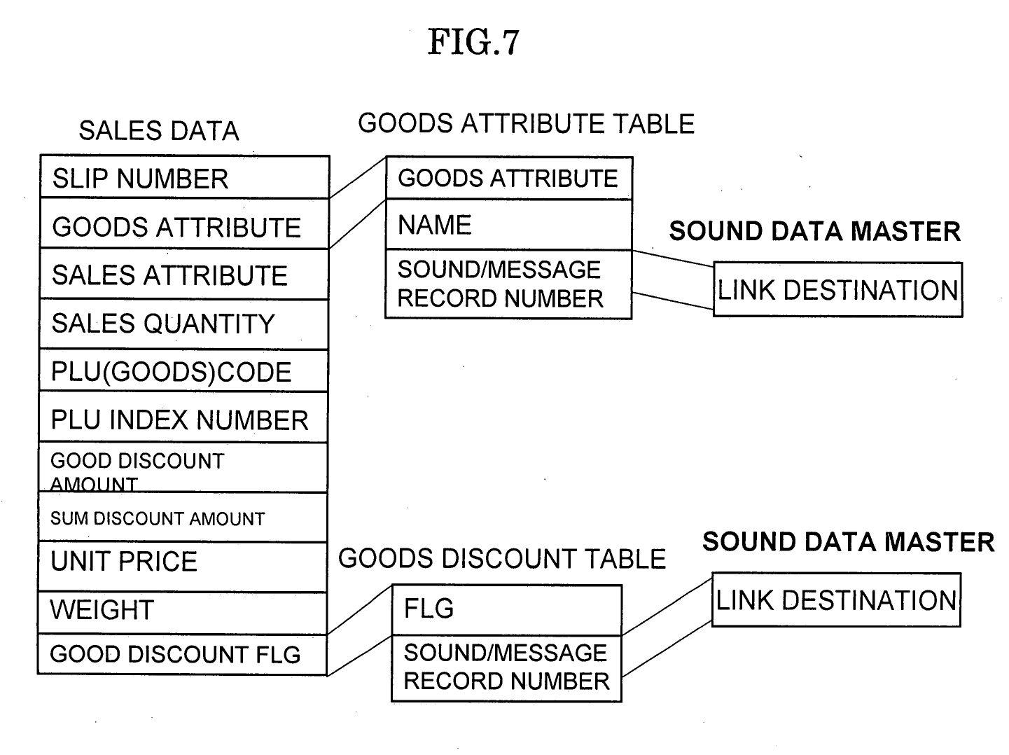

FIG. 7 is a view showing the relationship of sales data, goods attribute table, goods discount table and sound data master to one another.

The sales data includes slip number, goods attribute, sales attribute, sales quantity, PLU (goods) code, PLU index number, good discount amount, sum discount amount, unit price, weight, good discount FLG (flag). The goods attribute table includes goods attribute, name, and sound/message code number (No.). With the sound/message code number, sound data for generating the pertinent sound and/or message is stored in a sound data mask in a link destination. In a goods discount table of the good discount flags, flags and sound record numbers (No.) are stored in correspondence to one another. Also, sound data for generating sounds and/or messages are stored in the sound data mask in the link destination for the sound record numbers, respectively.

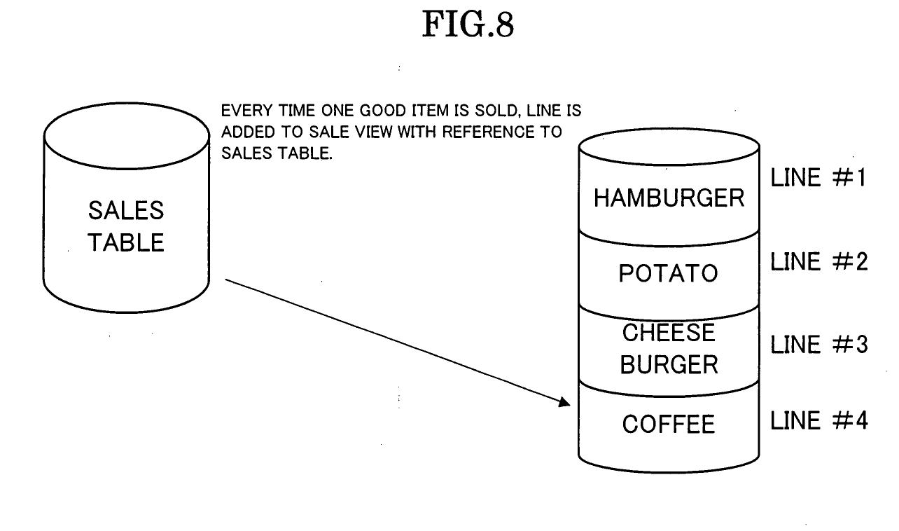

FIG. 8 shows an example of sales line data. Every time one good item is sold, “hamburger”, “potato”, “cheeseburger” and “coffee”, for instance, in line POS system touch panel key input systems #1 to #4, respectively, for instance, are added to the sales view with reference to the sales table.

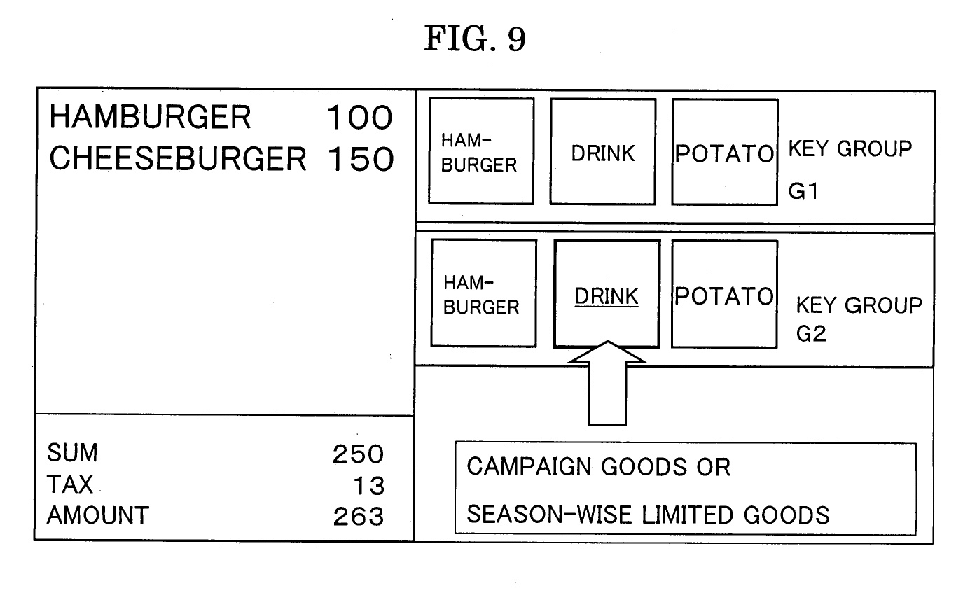

The operation of the embodiment of the present invention will be described in greater details with reference to FIG. 9 as a view display example. FIG. 9 is basically like the view example shown in FIG. 6. The view shows two key groups G1 ans G2 each including a hamburger key, a drink key and a potato key, and it is assumed that the Drink” contained in the ky group G2 is a campaign good a season-wise limited good.

In the case of this example, it is possible to link sounds and/or messages to the keys themselves for generation and output of a particular sound and/or message, but it is also possible to cause generation and output of sounds and/or messages assigned in key group correspondence. Without assignment of sounds and/or messages to the keys themselves, sounds and/or messages assigned to the key groups including the pertinent keys are generated and outputted. Thus, with the same good, different sounds and/or messages are generated and outputted depending on the key group, which the pertinent key belongs to. In a shop in which neither sound nor message is usually generated and outputted, such an arrangement may be made that a particular sound and/or message are generated and outputted when and only when a particular key group key is touched. With this arrangement, it is possible to cause generation and output of sounds and/or messages which are assigned to only campaign goods or season-wise limited goods.

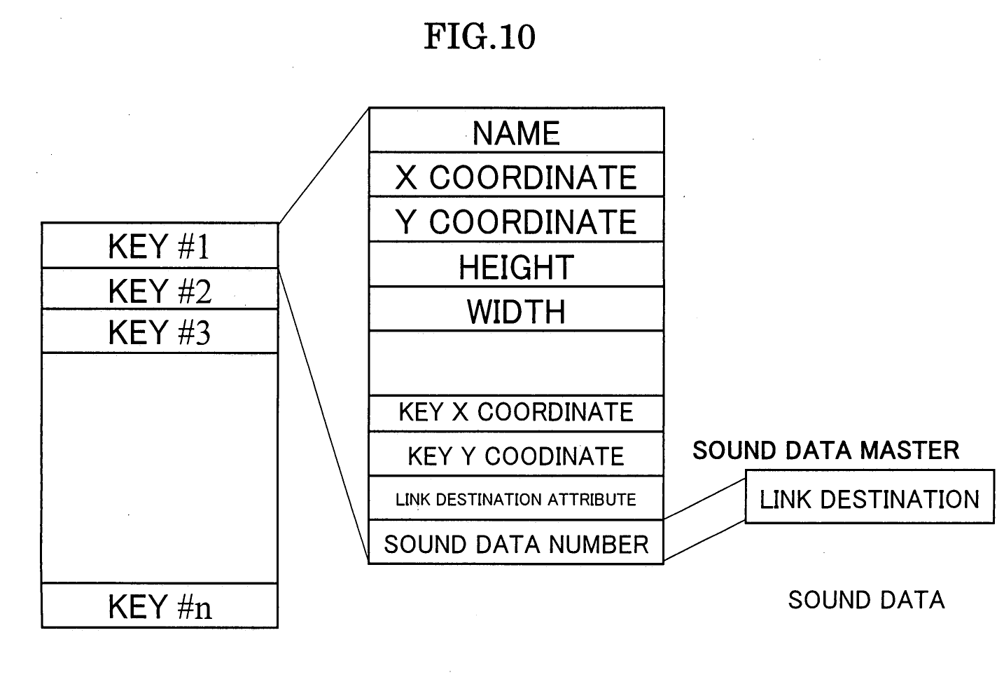

FIG. 10 is a sound data link view showing the relationship between keys and sound data. Pertaining to each of keys #1 to #n are name, X and Y coordinates in the view, height, width, . . . , key X and Y coordinates, link destination attribute and sound data number (No.). The sound data number is corresponded by a sound data master with sound data stored therein as link destination.

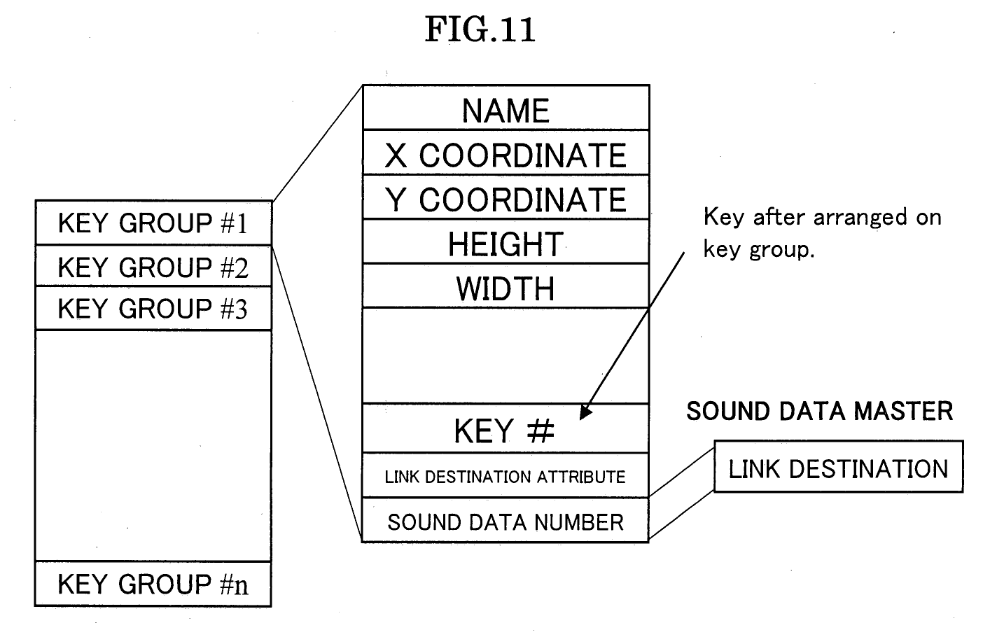

FIG. 11 is a sound data link view showing the relationship between key groups and sound data. Pertaining to each of key groups “1 to “n are, for each key, name, X and T coordinates in the view, height, width, . . . , key data disposed on the pertinent key group, link destination attribute and sound data number (No.). The sound data number is corresponded by a sound data master with sound data stored as link destination.

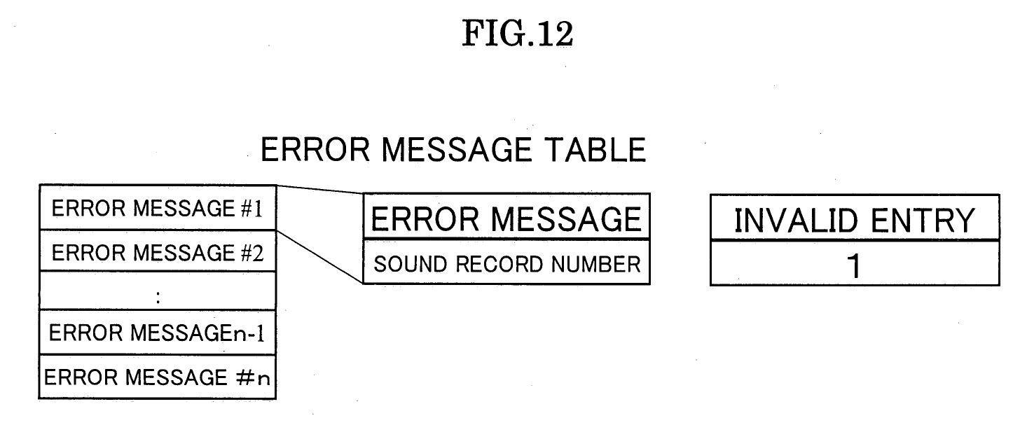

FIG. 12 shows error sound data configuration. To each of predetermined error messages “1” to “n” are corresponded by a pertinent error message a sound record number (No.), and invalid entry is set as “1”.

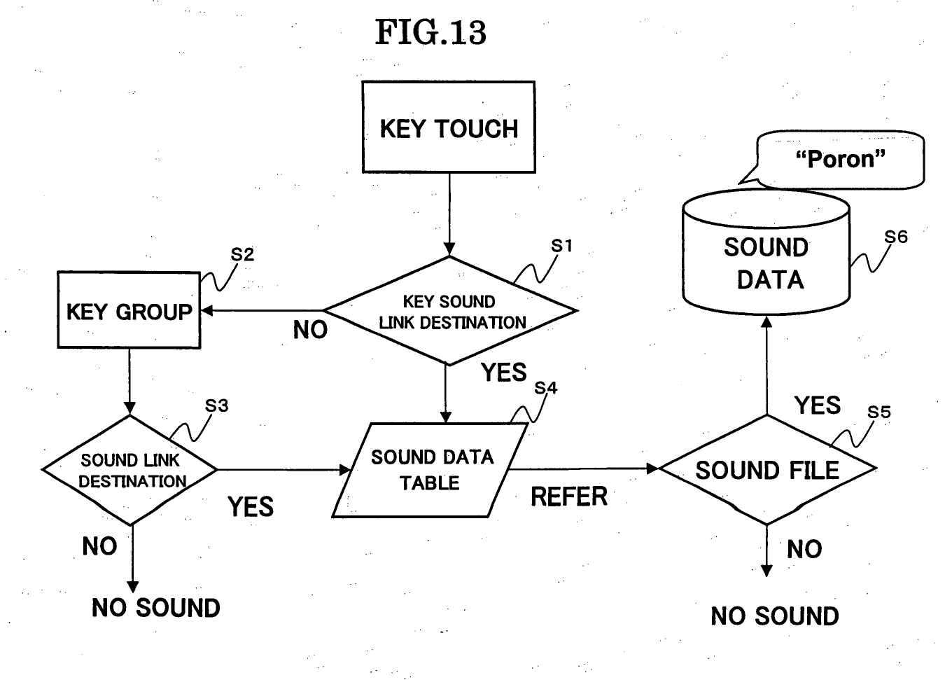

Now, the sound and/or message generation processing means according to the present invention will now be described with reference to FIG. 13.

At a key touch time, a check is made as to whether key sound and/or message generated and outputted in correspondence to the touched key have a link destination (step S1). When it is decided that there is no link destination, the key group of the touched key is found (step S2), and a check is made as to whether sound and/or message assigned to the key group have a link destination (step S3). When it is decided that no link destination is present, no sound and/or message are generated. When the link destination is found, a sound data—table is retrieved (step S4), and a check is made with reference to the sound data as to whether a sound file is present (step S5). When it is found in the step S1 that the key sound and/or message have a link destination, the step S4 is also executed for the sound data table retrieval, the step S5 is executed to check, with reference to the sound data, as to whether a sound file is present. When no sound file is found in the step S5, no sound is generated and outputted. When the sound file is present, sound data (of “bororon”, for instance) is generated and outputted.

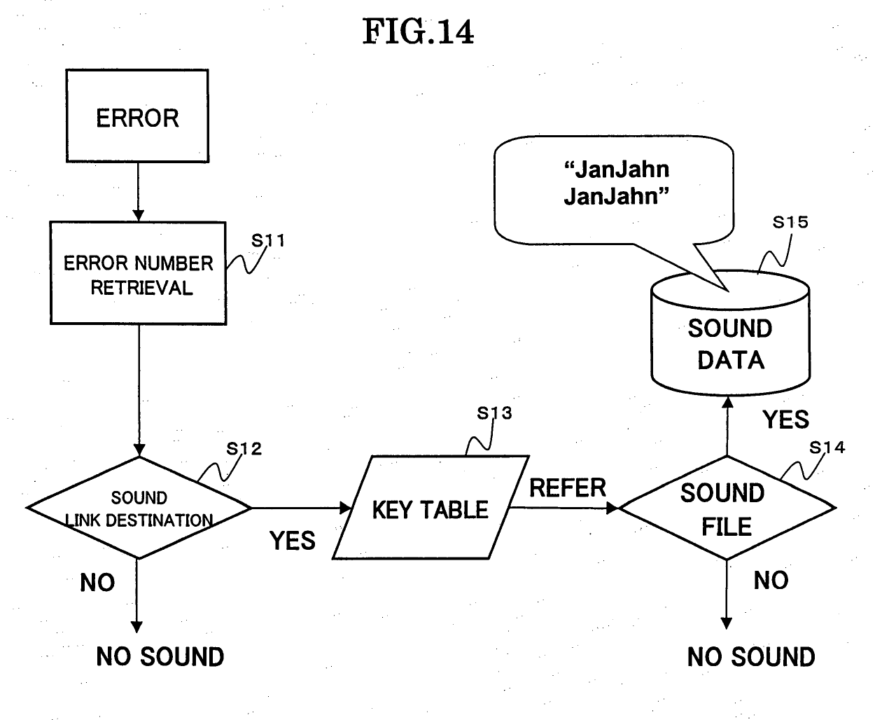

Now, the process flow of an error process routine or erroneous sound and/or message generation will be described with reference to FIG. 14.

At the time of error occurrence, the pertinent error number is retrieved for (step S11), and a check is made as to whether the retrieved error number has a corresponding link destination (step S12). When is decided that no link destination is present, no and and/or message are generated and outputted. When the link destination is found, a check is made, with reference to a key table (step S13), a check is made as to whether a corresponding sound file is present (step S14). When no sound file is fund in the step S14, no sound and/or message are generated and outputted. When the sound file is found, sound data (of “janjahn”, “janjahn, for instance, is generated and outputted.

The sound data assigned to the keys or key groups in the above description can be set as desired.

As has been described in the foregoing, with the touch panel key input system for POS system according to the present invention, particular sounds and/or messages are assigned in correspondence to keys or key groups, respectively, and particular sound and message are generated and outputted in response to a key touch. Thus, it is possible to facilitate the key operation confirmation and reduce input errors. Also, since sounds and/or message data can be set to the key groups, it is possible to permit easy conformation of the operation of a key belonging to a key group and improve the work efficiency. Furthermore, since it is possible, in the event a key operation includes an error or a serious problem, to cause generation and output of a special alarm, it is possible to cause generation and output of a predetermined sound and/or message corresponding to the gravity level (i.e., degree of hazard or seriousness) of the error. Thus, it is possible to realize more reliable operation and management.

Changes in construction will occur to those skilled in the art and various apparently different modifications and embodiments may be made without departing from the scope of the present invention. The matter set forth in the foregoing description and accompanying drawings is offered by way of illustration only. It is therefore intended that the foregoing description be regarded as illustrative rather than limiting.

1. A touch panel key input system for POS system for inputting desired data by key touch, wherein:
predetermined particular sounds and/or messages are assigned separately to a plurality of keys, respectively, and the assigned particular sounds and/or messages are generated and outputted in response to the touch to predetermined keys.

2. A touch panel key input system for POS system for inputting desired data by key touch, wherein:
predetermined sounds and/or messages are assigned to a key group having a plurality of keys, and the assigned particular sounds and/or messages are generated and outputted in response to the touch to keys, respectively, in the key group.

3. The touch panel key input system according to claim 1, wherein the particular sounds and/or messages each designate a next touch operation to be done.

4. A touch panel key input system for POS system for inputting desired data by key touch, wherein:
predetermined particular sounds and/or messages are assigned to erroneous touch operations, respectively, with respect to predetermined keys, and the assigned sounds and/or messages are generated and outputted in response to the erroneous touch operations, respectively.

5. The touch panel key input system for POS system according to claim 4, wherein the error touch operations are classified into a plurality of levels according to the gravity of the errors, the predetermined particular sounds and/or messages being assigned to the error gravity levels, respectively, and the assigned particular sounds and/or messages are generated and outputted in response to the error touch operation levels.

6. The touch panel key input system for POS system according to claim 4, wherein the erroneous touch operations are displayed in a view.

7. The touch panel key input system for POS system according to claim 4, wherein the particular sounds and/or messages are generated and outputted from a predetermined particular sound generator.

8. The touch panel item input system for POS system according to claim 6, wherein the display of the erroneous touch operations is made in a predetermined particular view.

9. The touch panel item input system for POS system according to claim 6, wherein the display of the erroneous touch operations is of a status different from the usual display status.

10. The touch panel item input system for POS system according to claim 6, wherein the display of the erroneous touch operations is a link display.

11. The touch panel item input system for POS system according to claim 5, wherein the plurality of levels of the error gravity is determined by the significance of the result of key touch operations.

12. The touch penal item input system for POS system according to claim 11, wherein the plurality of levels of error gravity are set up by assuming the case when a key which should not be operated from the consideration of immediately preceding input data is operated, the case when an ineffective key is operated, the case when numerical figures which should not be present are inputted from a ten-key set, the case when a key which can be readily used or for illegal operation such as a slip cancel key or a goods correction key and also a key which is allowed to be operated by a particular person such as manager are operated, and the case when a cash reception box is operated.

13. The touch panel key input system according to claim 2, wherein the particular sounds and/or messages each designate a next touch operation to be done.

14. The touch panel key input system for POS system according to claim 5, wherein the erroneous touch operations are displayed in a view.

15. The touch panel key input system for POS system according to claim 5, wherein the particular sounds and/or messages are generated and outputted from a predetermined particular sound generator.

16. The touch panel item input system for POS system according to claim 8, wherein the display of the erroneous touch operations is of a status different from the usual display status.

17. The touch panel item input system for POS system according to claim 8, wherein the display of the erroneous touch operations is a link display.

18. The touch panel item input system for POS system according to claim 9, wherein the display of the erroneous touch operations is a link display.
